(19) United States
(12) Patent Application Publication
(10) Pub. No.: US 2011/0186382 A1
(43) Pub. Date: Aug. 4, 2011

(54) FALL ARREST DEVICE

(75) Inventors: Robert Adam Sudale, Coventry (GB); Robert Hirst, Birmingham (GB)

(73) Assignee: UNIVERSITY SAFETY SYSTEMS LIMITED, Redditch, Worcestershire (GB)

(21) Appl. No.: 12/737,965

(22) PCT Filed: Sep. 3, 2009
(86) PCT No.: PCT/EP2009/061423

§ 371 Date: Apr. 11, 2011

(30) Foreign Application Priority Data
Sep. 6, 2008 (GB) 0816342.0

(51) Int. Cl. A62B 35/00; A62B 35/04

(52) U.S. Cl. 182/3

(57) ABSTRACT

A fall arrest device comprises a body (1) defining a path through the body for the passage of a track (3). A cam (21) is provided within the body for engaging with the track so as to control movement of the device relative to the track, and an arm (7) is provided for pivoting the cam within the body so as to move the cam towards and away from the track. The arm includes a first part (9) attached to the cam and a second part (11) for attachment to a user, the second part being pivotably connected to the first part. The body (1) is provided with an outwardly extending projection (13) which is dimensioned to contact the second part (11) of the arm over part of its movement.

This invention relates to a fall arrest device which is adapted to be mounted on fixed track, such as a cable or a rail. Such a device may be used in conjunction with vertical or inclined fall arrest systems.

It is well known in fall arrest systems to provide a fall arrest device which allows a user to attach to the fall arrest system at any point along its length, while allowing the user to remain attached whilst traversing the track, including passing any intermediate supports for the track. In the event of a slip or a fall from a structure to which the fall arrest system is attached, a load is applied to the device and the device locks onto the track by means of one or more pivotally mounted locking cams. Such systems are known, for example, from EP-A-0 272 782, WO-A-9609089 and WO-A-2005044383.

One problem associated with such known systems is that in certain circumstances the loading applied to the locking cam or cams may not move the cam(s) to a locking position.

It is therefore an object of the present invention to provide a fall arrest device which overcomes, or at least ameliorates, the above-described disadvantage.

According to the present invention there is provided a fall arrest device comprising a body defining a path therethrough for the passage of a track; a cam provided within the body for engaging with the track so as to control movement of the device relative to the track; and an arm for pivoting the cam within the body so as to move the cam towards and away from the track, wherein the arm includes a first part attached to the cam and a second part for attachment to a user, the second part being pivotably connected to the first part, and wherein the body is provided with an outwardly extending projection which is dimensioned to contact the second part of the arm over part of the movement thereof.

The arrangement of the first and second parts of the arm may be such that engagement between the second part and the projection causes relative rotation between the first and second parts.

The arrangement of the first and second parts of the arm may be such that only when the first part of the arm is independently moved towards the projection can sufficient leverage be obtained to withdraw the cam a sufficient distance to be able to mount the device on the track.

A track-engaging arm may be pivotably mounted in an upper region of the body for engagement with the track.

The first and second parts of the arm may be pivotable in substantially the same plane.

The projection may be dimensioned to contact only the second part of the arm.

Securing means, such as a karabiner, may be pivotably mounted at a free end of the second part of the arm. The securing means may be pivotable about an elongate axis of the second part of the arm. Means, such as a pin, may be provided to limit pivoting movement of the securing means.

The first and second parts of the arm may be configured to present a substantially continuous surface in the direction of the projection.

The second part of the arm and the karabiner may be configured to present a substantially continuous surface in the direction of the projection.

The second part of the arm may comprise a length of webbing which is provided with a cover adapted to contact the projection. The webbing may be incorporated into a tear pack. The cover may be provided with break-out notches at an end thereof, the notches being designed to fail at a predetermined load so as to transfer the load from the cover to the webbing.

For a better understanding of the present invention and to show more clearly how it may be carried into effect reference will now be made, by way of example, to the accompanying drawings in which:

FIG. 1 is a view from one side of an embodiment of a fall arrest device according to the present invention in a configuration for mounting on a track;

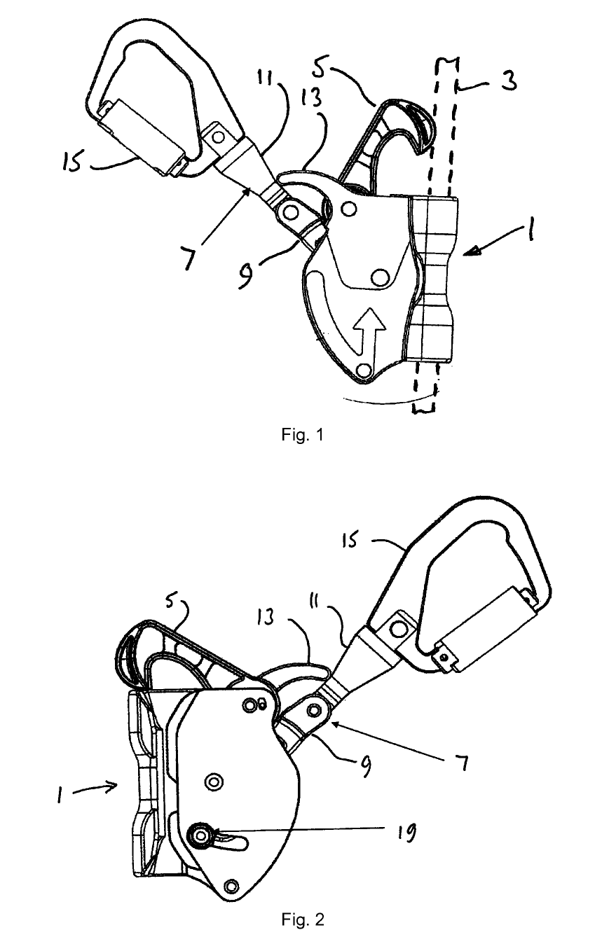

FIG. 2 is a view of the fall arrest device of FIG. 1 from the opposite side;

FIG. 3 shows part of the fall arrest device shown in FIGS. 1 and 2 on a larger scale;

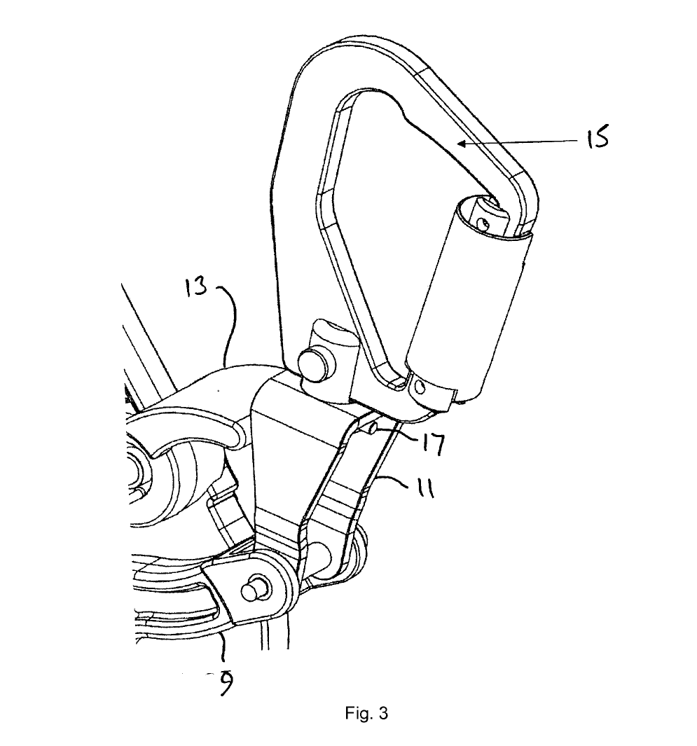

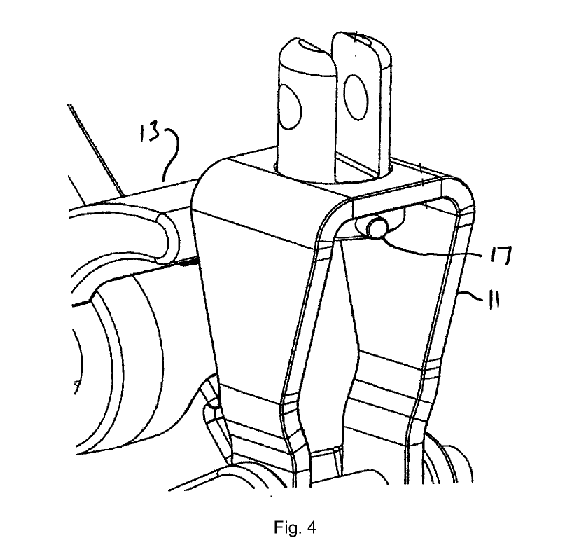

FIG. 4 corresponds to part of FIG. 3 with a karabiner removed;

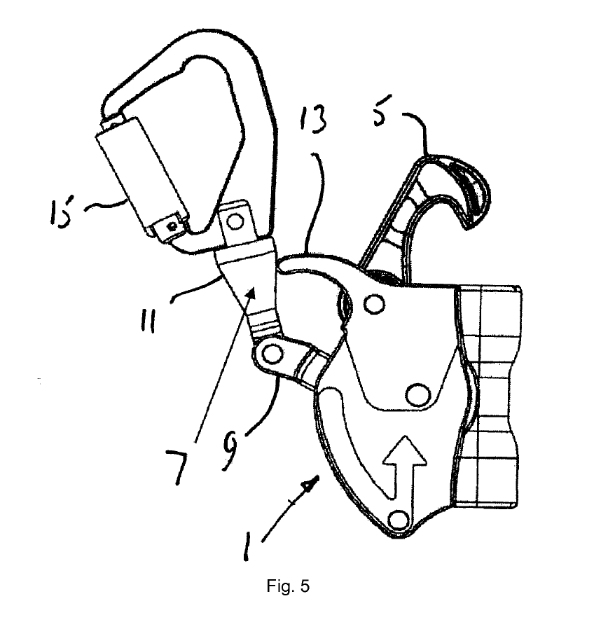

FIG. 5 is a side view of the fall arrest device shown in FIG. 1 in an in-use configuration;

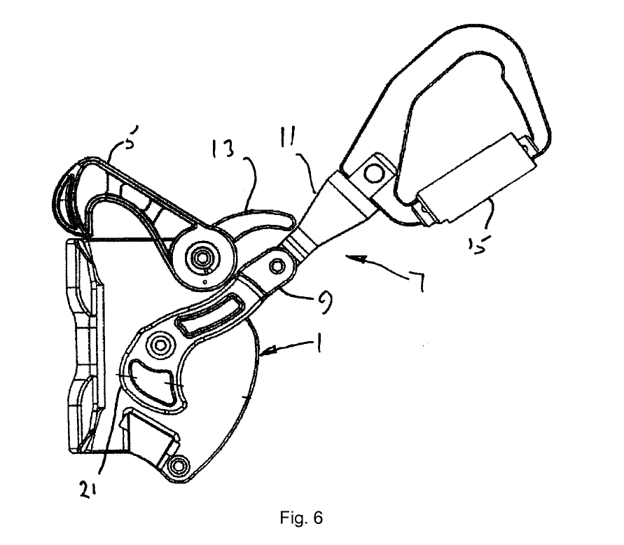

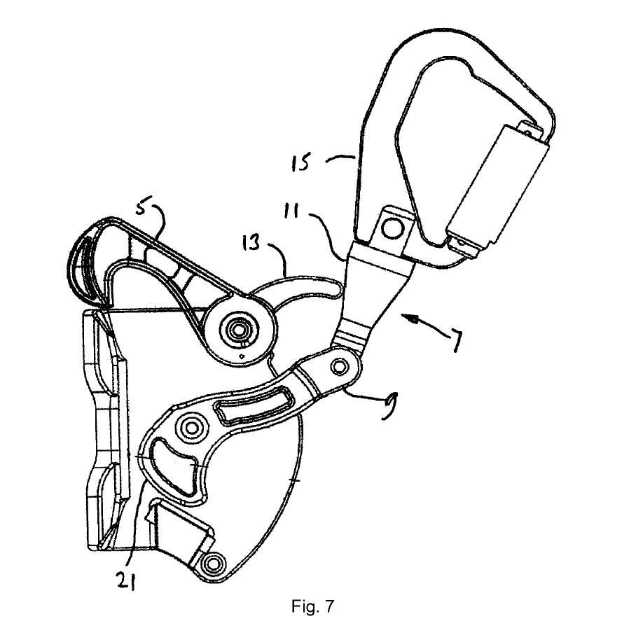

FIGS. 6 and 7 show the fall arrest device, with a front plate and locking plate removed for clarity, in open and in-use configurations respectively;

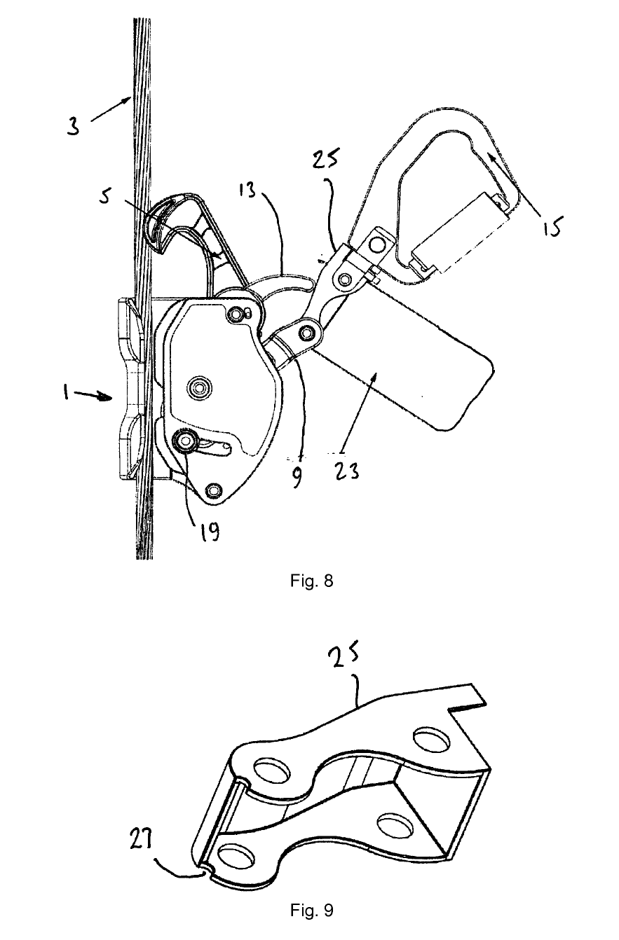

FIG. 8 is a side view of a modified fall arrest device incorporating a tear pack; and

FIG. 9 is a perspective view of a cover forming part of the tear pack shown in FIG. 8.

FIGS. 1 and 2 show a fall arrest device which comprises a body 1 which is formed therethrough with a path for the passage of a track in the form of a cable 3. A cable-engaging arm 5 is pivotably mounted at the top of the body 1 and is biased to engage with the cable 3 so as to restrain rotation of the body 1. A cam-operating arm 7 is pivotally mounted between opposing sides of the body 1, so as to pivot substantially in a single plane, and serves to urge a cam against the cable 3 in the event of a fall. The cam-operating arm 7 is formed in two parts, a first part 9 which is pivotally mounted within the body and extends outwardly from the body and a second part 11 which is pivotally mounted to a free end of the first part 9 so as to pivot relative to the first part in substantially the same pivot plane as the first part. The body 1 includes in an upper region thereof a projection 13, which may be formed integrally with the body or as a separate component, which extends in a direction away from the cable 3 and towards the cam-operating arm 7. The length and configuration of the projection 13 are such that an outer end of the projection engages only with the second part 11 of the cam-operating arm.

A karabiner 15 is pivotally mounted at a free end of the second part 11 for rotational movement about the axis of the second part. As shown in FIGS. 3 and 4, a pin 17 is provided within the second part to limit rotation of the karabiner. If desired, a separate karabiner can be provided or attached here.

As can be seen from FIG. 2, a locking pin 19 which is operated to allow the fall arrest device to be mounted on and removed from a cable 3. In order to accomplish either of these manoeuvres, the locking pin is first pulled outwardly and is then moved away from the cable location in order to draw back a locking plate. At the same time, the first part 9 of the cam-operating arm 7 is moved upwardly, but without any upward force on the karabiner 15, to retract the cam. When both of these operations have been accomplished the fall arrest device can be attached to, or removed from, the cable 3.

In use of the fall arrest device, the device is mounted on a cable 3 by first pulling the arm 5 away from the cable location, then pulling the locking pin 19 outwardly, and then moving the locking pin in a direction away from the cable location in order to draw back the locking plate. At the same time, the first part 9 of the cam-operating arm 7 is moved upwardly towards the projection 13. It is important that the first part 9 is moved (the second part 11 moving along with the first part) rather than the second part itself. If the second part 11 is moved upwardly towards the projection 13, for example by way of the karabiner 15, then the second part 11 will engage with the projection 13 and cause relative rotation between the first and second parts as shown in FIG. 5. The result of this is that the first part 9 is not moved sufficiently far towards the projection 13 in order to withdraw a cam 21 (see FIGS. 6 and 7) provided within the body 1 a sufficient distance to be able to mount the device on the cable. Only if the first part 9 is independently moved upwardly towards the projection 13 is it possible to obtain the required leverage to be able to withdraw the cam 21 a sufficient distance to be able to mount the device on the cable 3. Thus, the cam controls movement of the device relative to the cable, the cam being pivotable within the body so as to move the cam towards and away from the cable.

Once the device has been mounted on the cable, the arm 5, the first part 9 and the locking pin 19 can be released to secure the device on the cable. A user can then connect himself to the device by way of a conventional harness. When the user climbs a structure to which the cable is attached at intervals, he will pull the device upwardly along the cable as he climbs. In this case, however, pulling forces are applied to the karabiner 15 and therefore to the second part 11 of the cam-operating arm 7 and the second part is therefore able to pivot relative to the first part around the projection 13 as shown in FIGS. 5 and 7 and the cam 21 is movable only a small distance relative to the cable location. In the event of a fall, the karabiner and therefore the cam-operating arm will move downwardly to lock the fall arrest device onto the cable. Because the cam 21 is in use only movable a small distance relative to the cable location (as compared with mounting and removing the device from the cable) operation of the cam to arrest any fall is relatively quick and reduces the distance of any fall together with the speed attained by the falling person, thereby minimising any loads exerted on the user.

As can be seen from the figures, that region of the second part 11 of the cam-operating arm 7 remote from the first part 9 has a greater dimension than that region adjacent to the first part, while that region adjacent to the first part 9 has substantially the same dimension as the first part so as to present a substantially continuous profile between the first part 9 and the second part 11. The karabiner 15 is also preferably dimensioned to present a substantially continuous profile between the second part 11 and the karabiner. The effect of the substantially continuous profiles is that the components can readily move past the projection 13 without inhibiting relative movement between the cam-operating arm, the karabiner and the projection at any time.

As illustrated in FIG. 8, a tear pack 23 can replace the second part 11 of the cam-operating arm. A tear pack as such is well known and provides a way of absorbing energy during a fall, the tear pack containing a length of webbing which is folded and stitched together in a manner so that in the event of a fall the stitching fails progressively thereby absorbing energy. In the present case, the tear pack 23 also functions as the second part of the cam-operating arm 7 and to this end is provided with a cover 25, shown in more detail in FIG. 9, which is dimensioned to provide during normal use a substantially continuous profile between the first part 9 and the cover 25 and preferably also between the cover 25 and the karabiner 15. The tear pack 23 is attached at one end to the first part 9 and at the other end to the karabiner 15, in each case by way of a steel spindle which also passes through flanges which form part of the cover 25. The flanges in the region of the first part 9 are provided with break-out notches 27 such that the flanges are designed to fail at a predetermined load, such as will occur during a fall, so as to transfer the load to the webbing within the tear pack 23. The flanges will also absorb an amount of dynamic fall energy during failure.

As an alternative, the tear pack need not contain a length of folded, stitched webbing, but may contain a short length of webbing extending from one end of cover to the other. In the event of a fall, the break-out notches will fail, leaving the user supported by the short length of webbing which could be severed if needed when rescuing the fallen user.

1. A fall arrest device comprising a body (1) defining a path there-through for the passage of a track (3); a cam (21) provided within the body for engaging with the track so as to control movement of the device relative to the track; and an arm (7) for pivoting the cam within the body so as to move the cam towards and away from the track, wherein the arm includes a first part (9) attached to the cam and a second part (11) for attachment to a user, the second part being pivotably connected to the first part, and wherein the body is provided with an outwardly extending projection (13) which is dimensioned to contact the second part (11) of the arm over part of the movement thereof.

2. A fall arrest device as claimed in claim 1, wherein the arrangement of the first and second parts (9,11) of the arm (7) is such that engagement between the second part (11) and the projection (13) causes relative rotation between the first and second parts.

3. A fall arrest device as claimed in claim 1, wherein the arrangement of the first and second parts (9, 11) of the arm (7) is such that only when the first part (9) of the arm is independently moved towards the projection (13) can sufficient leverage be obtained to withdraw the cam (21) a sufficient distance to able to mount the device on the track (3).

4. A fall arrest device as claimed in claim 1, wherein a track-engaging arm (5) is pivotably mounted in an upper region of the body (1) for engagement with the track (3).

5. A fall arrest device as claimed in claim 1, wherein the first and second parts (9, 11) of the pivoting arm (7) are pivotable in substantially the same plane.

6. A fall arrest device as claimed in claim 1, wherein the projection (13) is dimensioned to contact only the second part (11) of the arm (7).

7. A fall arrest device as claimed in claim 1, wherein securing means (15) is pivotably mounted at a free end of the second part (11) of the arm (7).

8. A fall arrest device as claimed in claim 7, wherein the securing means comprises a karabiner (15).

9. A fall arrest device as claimed in claim 8, wherein the second part (11) of the arm (7) and the karabiner (15) are configured to present a substantially continuous surface in the direction of the projection (13).

10. A fall arrest device as claimed in claim 1, wherein the securing means (15) is pivotable about an elongate axis of the second part (11) of the arm (7).

11. A fall arrest device as claimed in claim 10, wherein means (17) is provided to limit pivoting movement of the securing means (15).

12. A fall arrest device as claimed in claim 11, wherein the limiting means comprises a pin (17).

13. A fall arrest device as claimed in claim 1, wherein the first and second parts (9, 11) of the arm (7) are configured to present a substantially continuous surface in the direction of the projection (13).

14. A fall arrest device as claimed in claim 1, wherein the second part (11) of the arm (7) comprises a length of webbing which is provided with a cover (25) adapted to contact the projection (13).

15. A fall arrest device as claimed in claim 14, wherein the webbing is incorporated into a tear pack (23).

16. A fall arrest device as claimed in claim 14 or 15, wherein the cover (25) is provided with break-out notches at an end thereof, the notches being designed to fail at a predetermined load so as to transfer the load from the cover to the webbing.
